(19) United States
(12) Patent Application Publication
(10) Pub. No.: US 2013/0212116 A1
(43) Pub. Date: Aug. 15, 2013

(54) METADATA ENGINE AND REPOSITORY

(71) Applicant: Post Pro Finance Co., Inc., (US)

(72) Inventor: Charles Maurice FILLIETTAZ, III, Cape Elizabeth, ME (US)

(73) Assignee: POST PRO FINANCE CO., INC., Encino, CA (US)

(21) Appl. No.: 13/766,649

(22) Filed: Feb. 13, 2013

Related U.S. Application Data
(60) Provisional application No. 61/598,265, filed on Feb. 13, 2012.

(51) Int. Cl. G06F 17/30

(52) U.S. Cl. CPC G06F 17/30923
USPC 707/755

(57) ABSTRACT

Systems, methods, and computer-readable storage media for using metadata from multiple sources to generate custom extensible markup language files for selected export targets. The system receives metadata associated with a media item and parses the metadata into a group of standardized fields to yield parsed metadata. The system then loads metadata style sheets, wherein each of the metadata style sheets is associated with a respective export target. Next, the system identifies a metadata style sheet from the metadata style sheets based on a selected export target to yield an identified metadata style sheet, and generates a custom extensible markup language file for submission with the media item to the selected export target, wherein the custom extensible markup language file is generated by assembling at least part of the parsed metadata according to the identified metadata style sheet.

### CROSS REFERENCE TO RELATED APPLICATIONS

This application claims the benefit of U.S. provisional application No. 61/598,265, filed on Feb. 13, 2012, which is expressly incorporated by reference herein in its entirety.

### BACKGROUND

1. Technical Field

The present disclosure relates to processing metadata and more specifically to packaging and managing metadata for export to different target formats.

2. Introduction

Currently, media vendors are responsible for wrangling, modifying, and integrating metadata elements as part of the final delivery of a media item to an online media catalog, store, or shop. However, the process of modifying and integrating metadata elements for a media item is typically onerous. Media vendors input the metadata in an extensible markup language file, and use the extensible markup language file to integrate the metadata into the media item according to specific formatting and requirements imposed by the particular media client. The formatting and requirements of the extensible markup language file generally varies for each media client. Thus, media vendors often spend a great deal of time editing, formatting, and correcting metadata to create different extensible markup language files for each media client. This process can be costly and terribly inefficient. Moreover, this process is prone to errors and missing metadata information. Yet the current solutions lack an effective mechanism for efficiently using, managing, and integrating metadata for media items, and checking the consistency of the metadata included in the final product.

### SUMMARY

Additional features and advantages of the disclosure will be set forth in the description which follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The approaches set forth herein can be used to improve the management, consistency, and ease of use of metadata for media items for ingestion into or distribution via various media distribution channels. Metadata from multiple sources can be combined to generate custom extensible markup language (XML) files for various target media clients. The metadata can be easily edited by users, and the edits can be automatically propagated to relevant sets of metadata and custom XML files. These approaches can greatly facilitate the process of editing metadata and XML files for the user, as any changes implemented by the user in one XML file for one target media client are propagated to relevant portions of metadata and/or XML files for other target media clients automatically regardless of the sources of the metadata. XML files and metadata from different sources can all be managed and modified from a single location, such as a unified display or dashboard. Moreover, the metadata and XML files can be maintained at a repository, and incorporated for generating future XML files for various media clients. The information maintained in the repository can be integrated into various media items regardless of the source of the metadata and/or the identity of the media client(s). Further, the metadata and XML files can be automatically checked for accuracy and consistency to reduce the number of errors in the metadata, as well as the time spent by media vendors correcting errors for the final product.

Disclosed are systems, methods, and non-transitory computer-readable storage media for using metadata from multiple sources to generate custom XML files for selected export targets. The system receives metadata associated with a media item and parses the metadata into a group of standardized fields to yield parsed metadata. The system can receive the metadata from one or more metadata sources, such as the internet movie database (IMDB), an online media shop, a vendor, an online repository, the Internet, etc. The system can also retrieve the metadata, or a portion of the metadata, from a local and/or remote database. In some embodiments, the system receives a portion of the metadata from IMDB and an online media shop, and retrieves another portion of the metadata from a local database. The system can select one or more of the metadata sources based on a parameter, a setting, a configuration, a user input, a characteristic of the metadata, an attribute, an availability of information, etc. For example, the system can select one or more of the metadata sources based on a request or input from a user. The user can select or identify metadata sources by, for example, dragging and dropping local files into a viewable portion of the display; entering addresses associated with the metadata sources, such as network addresses and/or uniform resource identifiers (e.g., uniform resource locators) into a form, a file, a page, an application, etc.; copying and pasting information into a form, a file, a page, an application, etc.; browsing and selecting files, such as local files and/or files on a web page; etc. The media item can include audio, video, text, an image, metadata, a file, and/or any other content. In some cases, the media item itself can include all or some metadata indicated by the various export targets. When importing metadata from multiple sources, certain metadata conflicts may arise where two different sources provide different values for a particular metadata field. The system can apply a priority hierarchy to select which value to use for the metadata field, or in extensible data structures such as XML the system can incorporate both values. A priority hierarchy can be predetermined based on trustworthiness of the metadata sources, or can be user-defined. The system can attempt to determine the type of conflict, such as whether the conflict is a simple misspelling, in which case the system can simply incorporate the proper spelling of the metadata for that field. The system can resolve these various metadata conflicts using one or more of these approaches.

When parsing the metadata into a group of standardized fields, the system can parse individual pieces of metadata from each metadata source into a group of standardized fields. The system can associate the various pieces of metadata with corresponding fields or elements in a data structure, a structured file, a database, etc. For example, the system can store the various pieces of metadata in corresponding cells, rows, and/or columns on a table. The system can flag potential issues and errors in the metadata and allow the user to edit metadata in metadata fields. This can be done in a “live” environment, such that the system flags potential issues and errors in the metadata as the metadata is received, and the user is subsequently presented with an opportunity to edit the metadata to correct the flagged issues and errors. The system can provide the user with strength-tested suggestions for correcting the flagged issues and errors. The strength-tested suggestions can come from outside metadata sources, such as IMDB and/or an online media shop, for example. The system can also perform an automatic verification of the metadata to ensure accuracy and/or allow the user to correct problems. In some cases, this process can reduce metadata errors by 40-50%.

The system and/or a user can identify a deficiency in the metadata, such as a missing portion of metadata for a particular desired export target or an error in the metadata, and search one or more metadata sources for metadata that resolves the deficiency in the metadata. The system can identify a metadata source having information which resolves the deficiency, and retrieve the information from the metadata source to resolve the deficiency. For example, the system can identify a spelling error in the metadata and search one or more metadata sources for the correct version of the metadata to correct the spelling error in the metadata. The system can then update the metadata with the correct version of the metadata to correct the deficiency in the metadata. As another example, the system can identify a missing portion of metadata, identify a metadata source having the missing portion of metadata, and retrieve the missing portion of metadata from the metadata source to correct the deficiency in the metadata. The system can store the metadata as it obtains the metadata from the metadata sources and/or as it updates, edits, and/or aggregates received metadata. The stored metadata can then be used to generate and/or update XML files and/or correct other metadata obtained from a source.

The system then loads metadata style sheets, wherein each of the metadata style sheets is associated with a respective export target. An export target can include a media content provider, an online media store, a media library, a media repository, a media content source, a media content distributor, a media content producer, a media content application, a media company, etc. Next, the system identifies a metadata style sheet from the metadata style sheets based on a selected export target to yield an identified metadata style sheet, and generates a custom XML file for submission with the media item to the selected export target, wherein the custom XML file is generated by assembling at least part of the parsed metadata according to the identified metadata style sheet. The metadata and/or the parsed metadata can be edited before or after assembling the parsed metadata. For example, the parsed metadata can be edited after the parsed metadata has been assembled, and the edited metadata can then be used to assemble the updated metadata according to the identified metadata style sheet. The edited metadata can also be used to assemble the updated metadata according to a different metadata style sheet in order to create a custom XML file for a different export target.

The export target can be selected based on a parameter, a setting, a configuration, a user input, a characteristic of the metadata style sheet, an attribute, a desired XML file, a destination of the custom XML file, etc. For example, the export target can be selected based on a request or input from a user. The user can select or identify the export target by, for example, dragging and dropping a metadata style sheet into a viewable portion of the display; entering information, such as a selection, into a form, a file, a page, an application, etc.; browsing and selecting the export target from an application, a file, a form, an XML file, a web page, a database, a display, etc.

The system can identify one or more additional metadata style sheets from the metadata style sheets based on one or more export target selections, and generate additional custom XML files for submission with the media item to the other export targets selected. Here, the additional custom XML files can be generated by assembling at least part of the parsed metadata according to the additional metadata style sheets. In some embodiments, the system can generate a separate custom XML file for submission with the media item to each of a plurality of export targets associated with the media style sheets. Here, the separate custom XML files can be generated by assembling at least part of the parsed metadata according to a respective metadata style sheet from the metadata style sheets. The system can perform an automatic verification of the metadata to check the accuracy of the metadata prior to generating the custom XML file. The system can also present the metadata to a user within a viewable display that allows the user to edit the metadata prior to and/or after generating the custom XML file. The system can also store the metadata and/or the custom XML file for future use in creating other custom XML files. For example, the system can store the metadata to create a pool of metadata, which can be used in the future to create custom XML files for selected export targets, and/or edit previous custom XML files.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system for generating custom XML files;

FIG. 2 illustrates an example user interface for a metadata engine;

FIG. 3 illustrates an example metadata table for a metadata engine;

FIG. 4 illustrates an example architecture for a metadata engine;

FIG. 5 illustrates an example server architecture for a metadata engine;

FIG. 6 illustrates an example method embodiment; and

FIG. 7 illustrates an example system embodiment.

### DETAILED DESCRIPTION

Various embodiments of the disclosure are described in detail below. While specific implementations are described, it should be understood that this is done for illustration purposes only. Other components and configurations may be used without parting from the spirit and scope of the disclosure.

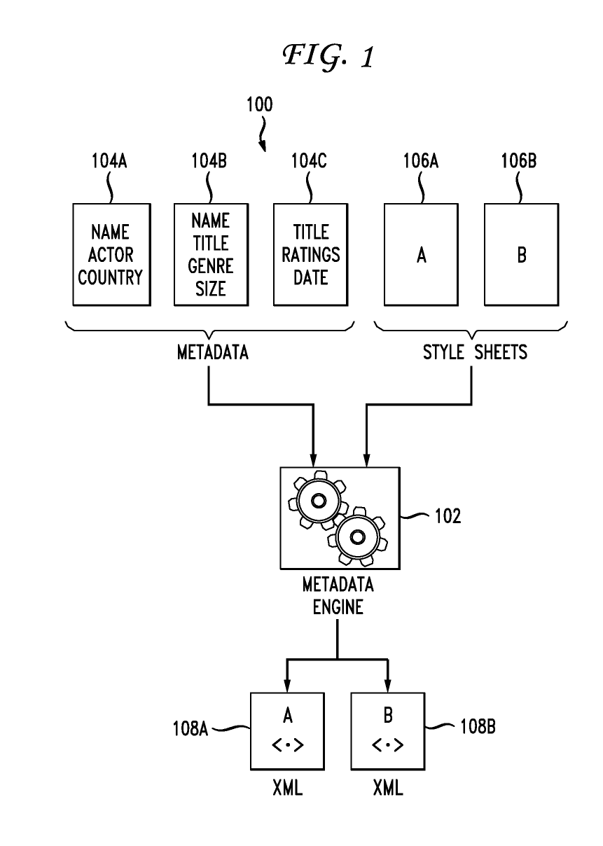

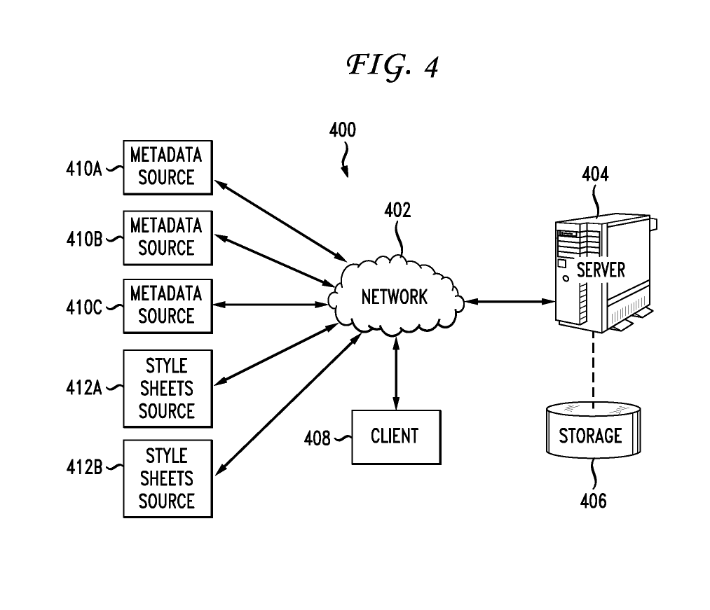

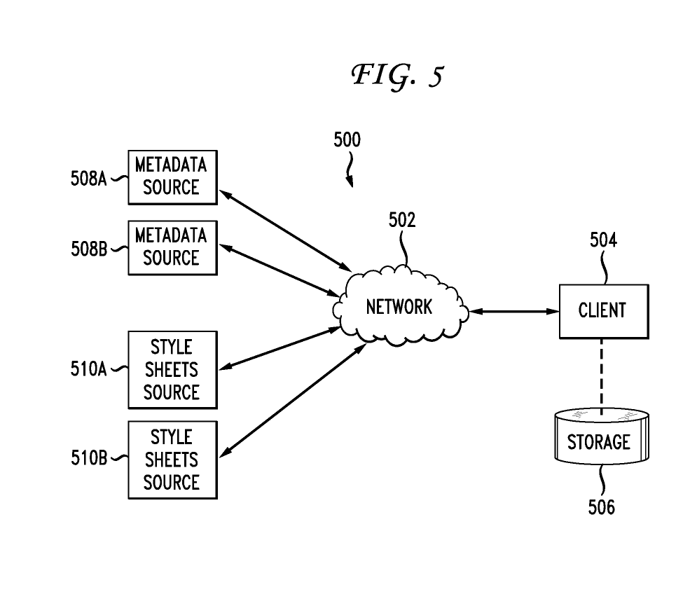

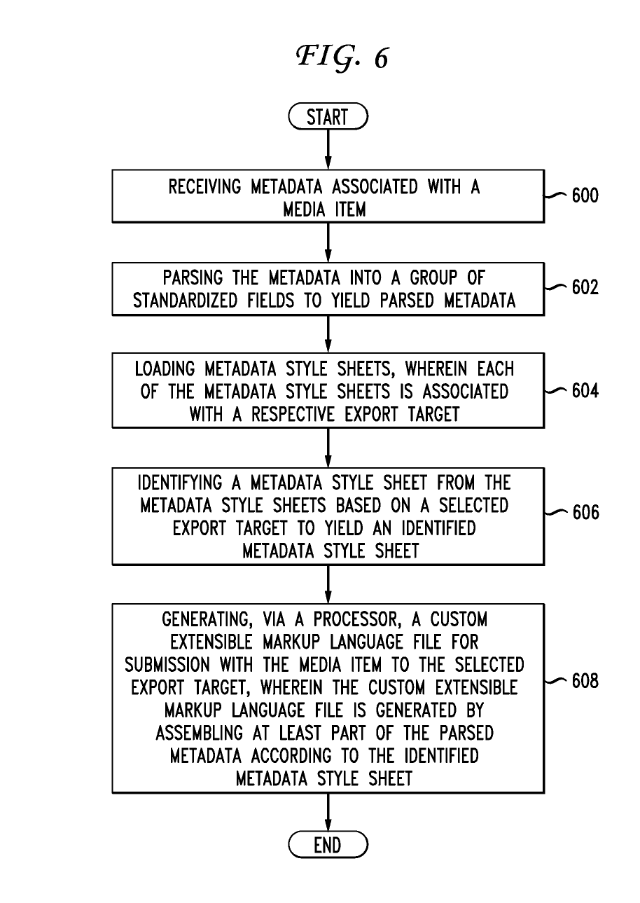

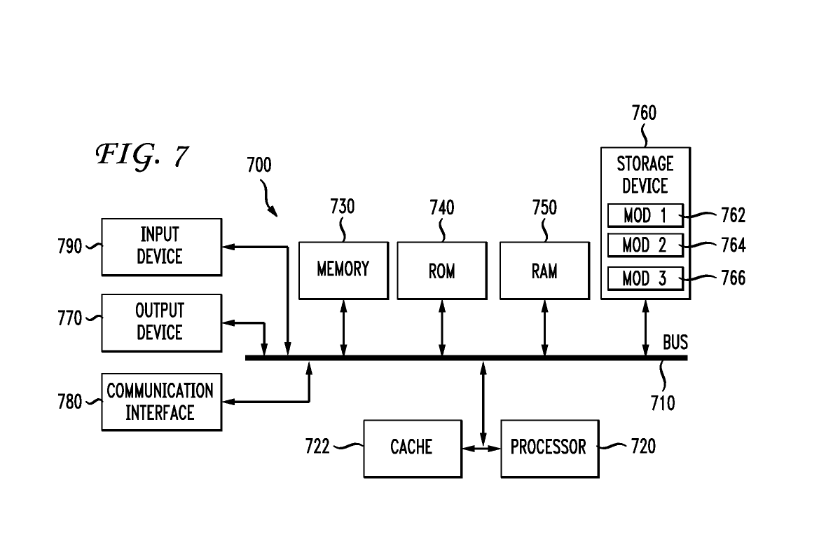

The present disclosure provides a way to generate custom XML files for export targets and collect metadata for generating custom XML files. A system, method and computer-readable media are disclosed which use metadata from multiple sources to generate custom XML files for selected export targets. A detailed description and variations of an interface and a metadata engine for generating custom XML files is disclosed herein. A description of exemplary architectures for generating custom XML files in FIGS. 4 and 5, a method for generating custom XML files in FIG. 6, and a basic general purpose system or computing device in FIG. 7, which can be employed to practice the concepts, will then follow. These variations shall be described herein as the various embodiments are set forth. The disclosure now turns to FIG. 1.

FIG. 1 illustrates an example system 100 for generating custom XML files. While the examples provided herein are described in terms of generating XML files for purposes of illustration, the system can also generate output in different formats which may be markup based or non-markup based, such as data in JavaScript Object Notation (JSON) format, a database, or flat text file. The system 100 can include a metadata engine 102 for processing metadata 104A-C and stylesheets 106A-B to generate custom XML files. The metadata engine 102 can be, for example, a software application, such as a standalone or web-based application, configured to generate custom XML files. Moreover, the metadata engine 102 can be configured to run/execute on any computing device, such as computing device 700 described in FIG. 7, discussed below.

The metadata engine 102 can receive metadata 104A-C for generating custom XML files 108A-B. The metadata 104A-C can be associated with a media item, such as a video, an image, audio, an application, a file, a text, a song, and/or any media content. For example, the metadata 104A-C can be associated with the movie “Titanic.” The metadata 104A-C can include any type of information associated with the media item. For example, the metadata 104A can include the name of the media item, the name of one or more actors associated with the media item, a country code, etc. The metadata 104B can include the name of the media item, the title of the movie the metadata 104A is associated with (e.g., Titanic), the genre of the movie, and the size of the media item. Metadata 104C can include the title of the movie (Titanic), the movie ratings, and the date of the movie. As one of ordinary skill in the art will readily recognize, the metadata 104A-C can include other information. These examples of metadata are provided for illustrative purposes.

The metadata 104A-C can originate from one or more sources, such as a local database, an online repository, a media distributor, a media outfit, a media producer, a media service, an online store, a media client, a media company, a website, a media application, etc. For example, metadata 104A can be retrieved from a local repository, metadata 104B can be downloaded from an online store, and metadata 104C can be retrieved from a spreadsheet or form provided by a media company. In some embodiments, the user and/or the system 100 can edit the metadata 104A-C before and/or after it is processed by the metadata engine 102. Moreover, the metadata engine 102 can perform an automatic verification of the metadata 104A-C to check the accuracy of the metadata before processing the metadata.

Once the metadata engine 102 receives the metadata 104A-C, it can parse the metadata into a group of standardized fields to map the metadata to corresponding fields of metadata. The metadata engine 102 can store the parsed metadata in a database, a table, a repository, a structured file, a spreadsheet, a folder, and/or any other file or storage element. The metadata engine 102 can also create a universal pool of metadata for use in creating custom XML files. Moreover, the metadata engine 102 can generate a unified display of the parsed metadata for presentation to a user. The user can then view and/or edit the parsed metadata from the unified display. When the user edits the parsed metadata, the metadata engine 102 can update the unified display to reflect the changes. The metadata engine 102 can also propagate the metadata changes to the various instances of metadata, corresponding fields, and/or any XML files associated with the metadata.

Prior to generating the custom XML files 108A-B, the metadata engine 102 loads style sheets 106A-B, which serve as templates, such as XML templates, for generating the custom XML files 108A-B. The style sheets 106A-B can be associated with specific export targets. For example, the style sheets 106A-B can be associated with one or more versions of Apple® iTunes®, YouTube©, Netflix™, Hulu™, Amazon.com™, etc. The metadata engine 102 can use a loaded and/or selected style sheet to assemble the metadata 104A-C in a specific order and/or arrangement, to generate a custom XML file for a corresponding export target associated with the style sheet used. This way, the metadata 102 can create custom XML files for different export targets based on the style sheets of the different export targets. For example, the metadata engine 102 can generate a custom XML file for submission with the media item to the selected export target. Here, the custom XML file can be generated by assembling the metadata according to a style sheet associated with the selected export target.

The metadata engine 102 can later re-use the custom XML files and/or metadata in new style sheets for other export targets. The metadata engine 102 can also update a custom XML file based on new metadata and/or changes to the metadata used to generate the custom XML file. For example, the metadata engine 102 can generate a unified display of the metadata 104A-C, the style sheets 106A-B, and/or the custom XML files 108A-B where a user can view and/or edit the metadata. When the user edits metadata in the unified display, the metadata engine 102 can propagate those changes to the custom XML files 108A-B to update the files.

The metadata engine 102 can include a language variance module, which adds additional suggestions or spellings for metadata in optional languages, and which can normalize commonly misspelled words or commonly abbreviated words (e.g., Wierd Al, Weird Al Yankovich, and Weird Al Yankovic are all different spellings/variations of the same intended metadata information). Moreover, the metadata engine 102 can flag potential issues and errors with the metadata, and allow the user to edit metadata fields in a ‘live’ environment using strength-tested suggestions from various outside metadata sources, such as IMDB, an online media shop, an online repository, a remote database, etc. The metadata engine 102 can perform an automatic verification to ensure accuracy and/or allow the user to correct problems, for example.

Metadata assets (including closed caption files, subtitle information, and other metadata information) can also be captured, extracted, and delivered in a similar closed ecosystem. The metadata engine 102 can process metadata assets via a secure, web-based “online repository,” which can optionally integrate directly with an application programming interface (API), or another interface, such as Apple® iTunes® Connect, for example. Cataloguing this valuable, fungible data inside a closed ecosystem can prevent repeat errors, and can leverage these materials in different territories for future uses. This approach can also help standardize metadata delivery for less expensive integration with a higher degree of accuracy and fewer errors. The metadata engine 102 can allow users to create, edit, verify, and compile XML metadata and metadata in other forms, from multiple sources, for translation into standardized format fields, allowing the user to review and compare the metadata from multiple sources in a live editing environment. The metadata engine 102 can also export the metadata into various formats for ingestion or submission into different online repositories.

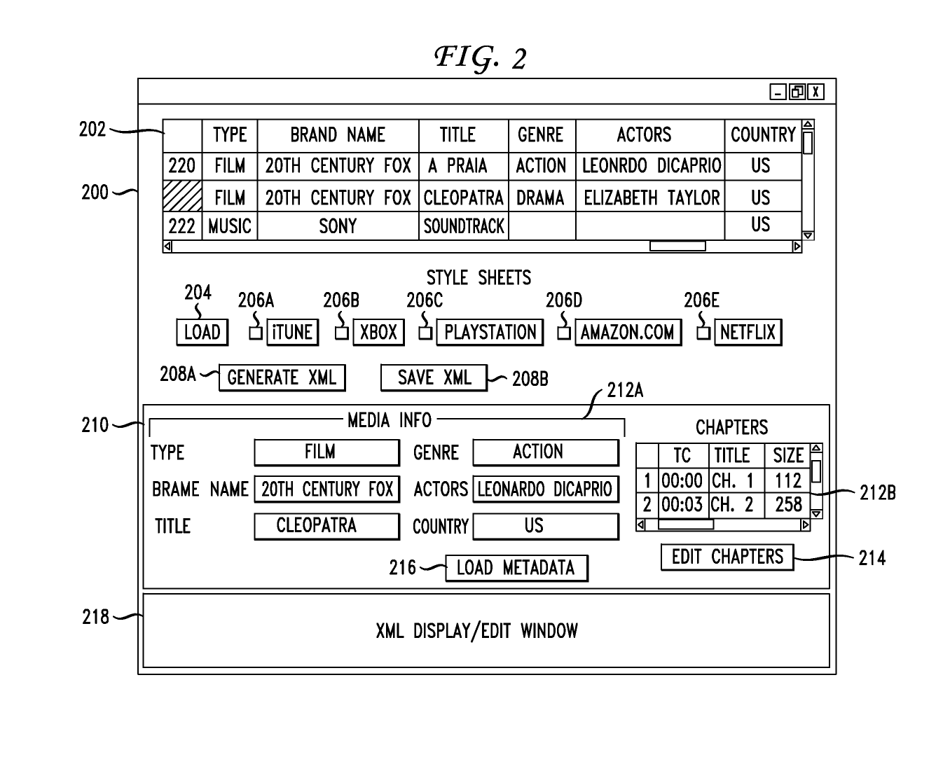

FIG. 2 illustrates an example user interface for a metadata engine. Here, the user interface includes a unified display 200 for presenting metadata and XML files. The user can also edit, load, and/or save the metadata or XML files through the unified display 200. The unified display 200 includes a main metadata page 202 where the user can view and/or edit metadata imported into the system. The user can review the main metadata page 202 to confirm that the correct metadata has been imported to the correct fields. If the user identifies an error in the metadata, the user can edit the metadata from the main metadata page 202 to correct the error. The user can also input additional metadata directly in the main metadata page 202 and/or load additional metadata from an external source. For example, the user can drag and drop a metadata file and/or browse and upload a metadata file to import additional metadata into the main metadata page 202. The metadata file can be any file with metadata values, such as a spreadsheet file or a comma-separated values file, for example. The load button 204 allows the user to load style sheets for export targets. The user can select one or more style sheets through the style sheet selection buttons 206A-E.

The generate XML button 208A allows the user to generate a custom XML file for the metadata based on the selected style sheet(s). When the generate XML button 208A is activated, the metadata engine takes the metadata and selected style sheets and generates the custom XML file. The custom XML file can combine the metadata from various sources into an XML file that is appropriate for an export target based on the export target's style sheet(s). Moreover, the metadata engine allows the user to generate multiple different styles of XML files simultaneously using stored style sheets. Moreover, the save XML button 208D allows the user to save the XML file generated when the generate XML button 208A is activated. The save XML button 208D can affect the edited metadata from the metadata import window 210, the chapter stop metadata window 212B, style sheet templates, and other edits in the main metadata page 202. Moreover, the save XML button 208D can write this information into individual XML scripts for each piece of media and each selected style sheet format. These new files can be exported and/or saved for later use.

The XML display window 216 displays the custom XML file generated by the metadata engine when the generate XML button 208A is activated. The user can essentially preview, in different formats, how the custom XML file will appear when exported. The user can view and/or edit the custom XML file directly from the XML display window 216. Alternatively, the user can update the XML file by editing the metadata and selecting the generate XML button 208A to propagate the changes in metadata to the XML file.

The user can edit the metadata directly through the main metadata page 202 and/or the metadata import window 210. The metadata import window 210 includes a loaded metadata display portion 212A and a chapter stop metadata window 212B, associated with metadata imported into the system. The user can load metadata into the system from a metadata file using the load metadata button 216. When the user uploads metadata through the load metadata button 216, the user can view the loaded metadata through the metadata import window 210 and make changes to the metadata directly from the metadata import window 210. The user can also edit chapter information through the chapter stop metadata window 212B. Moreover, the edit chapters button 214 can allow the user to locate and load chapter stop metadata from an outside file and/or a standard chapter stop metadata input form. In some embodiments, the media item may not include chapters and, therefore, the metadata import window 210 may not include the chapter stop metadata window 212B. Instead, the metadata import window 210 may include a window for other information associated with the loaded metadata and/or media item, such as frames, tracks, versions, tags, etc.

In some embodiments, the user can select the load metadata button 216 to browse a local file for importing metadata into the system. In other embodiments, the user can also import metadata into the system by specifying a network address pointing to the metadata to be imported, such as a network share, a uniform resource locator, a web address, an rich site summary (RSS) feed, and so forth. In yet other embodiments, the user can simply import metadata into the system by dragging and dropping a file into the unified display 200.

Metadata can be exported as an XML file. Moreover, the metadata can also be uploaded directly to a file transfer protocol (FTP) site and/or an online service. For example, the metadata can be uploaded to an online service via a web interface or an API call. The metadata and/or XML files can be viewed and/or edited live, or saved for future viewing and/or editing.

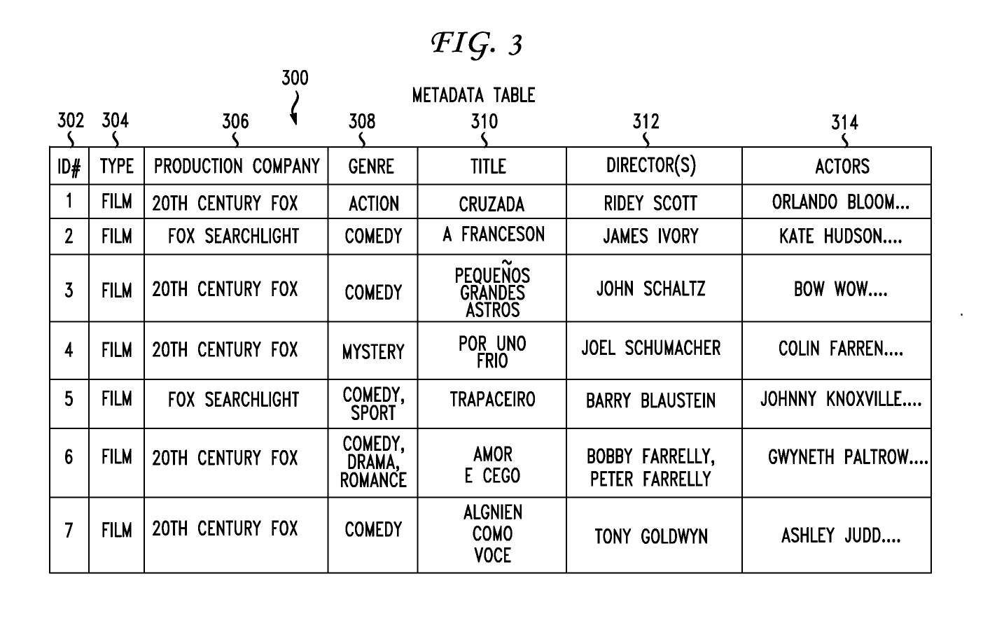

FIG. 3 illustrates an example metadata table 300 for a metadata engine. The metadata table 300 can include groups of standardized fields 302-314 for storing metadata. The metadata table 300 can include multiple metadata fields for various types of media, such as video, audio, photo, text, application, etc. The metadata table 300 can store metadata from multiple metadata sources for use by a metadata engine in generating custom XML files for export targets. The metadata table 300 can store portions of metadata from different sources and edited metadata to be processed by the metadata engine for generating custom XML files in the future. This way, the metadata table 300 can serve as a pool of metadata and/or metadata repository for media items and/or custom XML files. Moreover, the metadata table 300 can be one of many metadata tables in a metadata repository. Here, the metadata table 300 can be related and/or linked to other metadata tables in the metadata repository. For example, the metadata table 300 can include a primary key, which is used as a secondary key at one or more other metadata tables. The metadata table 300 can be updated as metadata is added, edited, and/or deleted.

FIG. 4 illustrates an example architecture 400 for a metadata engine. The server 404 can include a metadata engine for generating custom XML files using metadata from various metadata sources 410A-C. The custom XML file can include metadata associated with a particular media item. The metadata can include any type of metadata associated with the media item. A media item can include any type of media content, such as a video, an image, a song, a file, an application, audio, text, etc. The metadata engine can be a standalone or web-based application on the server 404. The server 404 and the client 408 can be any device with networking capabilities, such as a laptop, a tablet computer, a server, a smartphone, a media player, a smart television, a portable device, etc. Moreover, the client 408 can include, for example, an export target requesting a custom XML file for a media item. The export target can include a media service and/or application, such as Apple® iTunes®, YouTube©, Netflix™, Hulu™, etc.

The server 404 can receive metadata from the metadata sources 410A-C via network 402. The server 404 can also receive style sheets from style sheet sources 412A-B via network 402. The network 402 can include a public network, such as the Internet, but can also include a private or quasi-private network, such as an intranet, a home network, a virtual private network (VPN), a shared collaboration network between separate entities, etc. Indeed, the principles set forth herein can be applied to many types of networks, such as local area networks (LANs), virtual LANs (VLANs), corporate networks, wide area networks, and virtually any other form of network. The style sheets can include metadata templates associated with specific export targets. Moreover, the style sheets can define how metadata should be formatted and/or organized for the corresponding export targets. Furthermore, the metadata sources 410A-C can include an online store, an online repository, a media service provider, a media distributor, a media producer, a media customer, a remote database, a metadata repository, etc.

The server 404 can store the metadata in a metadata repository 406 for future use by the metadata engine. The metadata repository 406 can be a local storage on the server 404 or a remote storage on another device, for example. In some embodiments, the metadata repository 406 is an online repository. Here, the server 404 can communicate with the online repository to store the metadata and/or style sheets via network 402. The server 404 can parse the metadata it receives into a group of standardized fields to map the metadata with corresponding fields. Moreover, the server 404 can store the metadata in a table, a database, a structured file, a list, an object, etc.

Once the server 404 receives the metadata and style sheets, it can generate one or more custom XML files based on the metadata (or a portion thereof) and one or more selected style sheets. The server 404 can also gather additional metadata to supplement the metadata from the metadata sources 410A-C, and use the combined metadata to generate one or more custom XML files. For example, the server 404 can gather metadata stored locally, such as metadata in a local spreadsheet, metadata stored in the metadata repository 406, and/or metadata from the Internet, supplement the metadata from the metadata sources 410A-C with the additional metadata gathered by the server 404, and use the combined metadata to generate a custom XML file. The server 404 can assemble the metadata, or a portion thereof, according to one or more selected style sheets to generate the one or more custom XML files.

Once the server 404 generates the custom XML files, it can send the files to the client 408 via network 402. The server 404 can also send to the client 408 a media item associated with the metadata and/or the custom XML. Moreover, the server 404 can also store the custom XML files in a storage on the server 404 and/or the metadata repository 406, for future use in creating custom XML files. In some embodiments, the server 404 displays the custom XML files on a web interface, which the client 408 can access via network 402 to view, edit, and/or download the custom XML files and/or metadata. When a user edits a portion of the metadata and/or the custom XML file, the changes can be propagated to other portions of the metadata and/or the custom XML file. For example, when the user edits a portion of the metadata, the server 404 can update the custom XML file to reflect the changes made by the user to the metadata. The user can also edit the metadata after the server 404 receives the metadata from the metadata sources 410A-C and before the server 404 generates the custom XML file. This way, the user can ensure that the combined metadata used to create the custom XML file is accurate.

In some embodiments, the client 408 is an export target requesting a custom XML file for a media item. Here, the server 404 can use the metadata received from the metadata sources 410A-C and/or metadata stored at the metadata repository 406 to generate the custom XML file for the export target, based on a style sheet associated with the export target. The server 404 can then send the custom markup language file to the client 408 and/or serve the custom markup language file and/or metadata to the client 408 via a web interface. The web interface can present the information in a unified display, such as the unified display 200, illustrated in FIG. 2 above.

FIG. 5 illustrates an example server architecture 500 for a metadata engine. Here, the client 504 can include a metadata engine for generating custom XML files using metadata from various metadata sources 508A-B. The custom XML file can include metadata associated with a particular media item. The metadata can include any type of metadata associated with the media item. A media item can include any type of media content, such as a video, an image, a song, a file, an application, audio, text, etc. The client 504 can be any device with networking capabilities, such as a laptop, a tablet computer, a server, a smartphone, a media player, a smart television, a portable device, etc. Moreover, the client 504 can include, for example, an export target requesting a custom XML file for a media item. The export target can be an application on the client 504, such as a standalone application, for example. Further, the export target can include a media service and/or application, such as Apple® iTunes®, YouTube©, NetFlix™, Hulu™, etc.

The client 504 can receive metadata from the metadata sources 508A-B via network 502. The client 504 can also receive style sheets from style sheet sources 510A-B via network 502. The network 502 can include a public network, such as the Internet, but can also include a private or quasi-private network, such as an intranet, a home network, a virtual private network (VPN), a shared collaboration network between separate entities, etc. Indeed, the principles set forth herein can be applied to many types of networks, such as local area networks (LANs), virtual LANs (VLANs), corporate networks, wide area networks, and virtually any other form of network. The metadata sources 508A-B can include an online store, an online repository, a media service provider, a media distributor, a media producer, a media customer, a remote database, a metadata repository, etc. The style sheets can include metadata templates associated with specific export targets. The style sheets can define how metadata should be formatted and/or organized for the corresponding export targets.

The client 504 can store the metadata in a metadata repository 506 for future use by the metadata engine. The metadata repository 506 can be a local storage on the client 504 or a remote storage on another device, for example. In some embodiments, the metadata repository 506 is an online repository. Here, the client 504 can communicate with the online repository to store the metadata and/or style sheets via network 502. The client 504 can parse the metadata it receives into a group of standardized fields to map the metadata with corresponding fields. Moreover, the client 504 can store the metadata in a table, a database, a structured file, a list, an object, etc.

Once the client 504 receives the metadata and style sheets, it can generate one or more custom XML files based on the metadata (or a portion thereof) and one or more selected style sheets. The client 504 can also gather additional metadata to supplement the metadata from the metadata sources 508A-B, and use the combined metadata to generate one or more custom XML files. For example, the client 504 can gather metadata stored locally, such as metadata in a local spreadsheet, and/or metadata from the Internet, supplement the metadata from the metadata sources 508A-B with the local metadata and/or the metadata from the Internet, and use the combined metadata to generate a custom XML file. The client 504 can assemble the metadata, or a portion thereof, according to one or more selected style sheets to generate the one or more custom XML files.

Moreover, the client 504 can display the custom XML files on a unified display, which users can use to view, edit, and/or access the custom XML files and/or the metadata. When a user edits a portion of the metadata and/or the custom XML file, the changes can be propagated to other portions of the metadata and/or the custom XML file. For example, when the user edits a portion of the metadata, the client 504 can update the custom XML file to reflect the changes made by the user to the metadata. The user can also edit the metadata after the client 504 receives the metadata from the metadata sources 508A-B and before the client 504 generates the custom XML file. This way, the user can ensure that the combined metadata used to create the custom XML file is accurate.

Having disclosed some basic system components and concepts, the disclosure now turns to the example method embodiment shown in FIG. 6. For the sake of clarity, the method is described in terms of an example system 700, as shown in FIG. 7 below, configured to practice the method. The steps outlined herein are illustrative and can be implemented in any combination thereof, including combinations that exclude, add, or modify certain steps.

FIG. 6 illustrates an example method embodiment. The system 700 receives metadata associated with a media item (600) and parses the metadata into a group of standardized fields to yield parsed metadata (602). The system 700 can receive the metadata from one or more metadata sources, such as IMDB, an online media shop, a vendor, an online repository, the Internet, etc. The system 700 can also retrieve the metadata, or a portion of the metadata, from a local and/or remote database. In some embodiments, the system 700 receives a portion of the metadata from IMDB and an online media shop, and retrieves another portion of the metadata from a local database. The system 700 can select one or more of the metadata sources based on a parameter, a setting, a configuration, a user input, a characteristic of the metadata, an attribute, an availability of information, etc. For example, the system 700 can select one or more of the metadata sources based on a request or input from a user. The user can select or identify metadata sources by, for example, dragging and dropping local files into a viewable portion of the display; entering addresses associated with the metadata sources, such as network addresses and/or uniform resource identifiers (e.g., uniform resource locators) into a form, a file, a page, an application, etc.; copying and pasting information into a form, a file, a page, an application, etc.; browsing and selecting files, such as local files and/or files on a web page; etc. The media item can include audio, video, text, an image, metadata, a file, and/or any other content.

When parsing the metadata into a group of standardized fields, the system 700 can parse individual pieces of metadata from each metadata source into a group of standardized fields, which can be established in advance, or which can be determined based on a set of indicated export targets and any associated metadata fields required for those indicated export targets. The system 700 can associate the various pieces of metadata with corresponding fields or elements in a data structure, a structured file, a database, an object, etc. For example, the system 700 can store the various pieces of metadata in corresponding cells, rows, and/or columns on a table. The system 700 can flag potential issues and errors in the metadata and allow the user to edit metadata in metadata fields. This can be done in a “live” environment, such that the system 700 flags potential issues and errors in the metadata as the metadata is received, and the user is subsequently presented with an opportunity to edit the metadata to correct the flagged issues and errors. The system 700 can provide the user with strength-tested suggestions for correcting the flagged issues and errors. The strength-tested suggestions can come from outside metadata sources, such as IMDB and/or an online media shop, for example. The system 700 can also perform an automatic verification of the metadata to ensure accuracy and/or allow the user to correct problems. As the user makes changes to metadata, those changes can be propagated down to derivative exported XML files, sideways to sibling metadata sources, or up to the source from which the metadata was received.

The system 700 and/or a user can identify a deficiency in the metadata, such as a missing portion of metadata or an error in the metadata, and search one or more metadata sources for metadata which resolves the deficiency in the metadata. The system 700 can identify a metadata source having information which resolves the deficiency, and retrieve the information from the metadata source to resolve the deficiency. For example, the system 700 can identify a spelling error in the metadata and search one or more metadata sources for the correct version of the metadata to correct the spelling error in the metadata. The system 700 can then update the metadata with the correct version of the metadata to correct the deficiency in the metadata. As another example, the system 700 can identify a missing portion of metadata, identify a metadata source having the missing portion of metadata, and retrieve the missing portion of metadata from the metadata source to correct the deficiency in the metadata. The system 700 can store the metadata as it obtains the metadata from the metadata sources and/or as it updates, edits, and/or aggregates received metadata. The stored metadata can then be used to generate and/or update XML files and/or correct other metadata obtained from a source.

The system 700 then loads metadata style sheets, wherein each of the metadata style sheets is associated with a respective export target (604). An export target can include, for example, a media content provider, an online media store, a media library, a media repository, a media content source, a media content distributor, a media content producer, a media content application, a media company, a media service, etc. Next, the system 700 identifies a metadata style sheet from the metadata style sheets based on a selected export target to yield an identified metadata style sheet (606), and generates a custom XML file for submission with the media item to the selected export target, wherein the custom XML file is generated by assembling at least part of the parsed metadata according to the identified metadata style sheet (608). The metadata and/or the parsed metadata can be edited before or after assembling the parsed metadata. For example, the parsed metadata can be edited after the parsed metadata has been assembled, and the edited metadata can then be used to assemble the updated metadata according to the identified metadata style sheet. The edited metadata can also be used to assemble the updated metadata according to a different metadata style sheet in order to create a custom XML file for a different export target.

The export target can be selected based on a request, a media item, an application, a service, a parameter, a setting, a configuration, a user input, a characteristic of the metadata style sheet, an attribute, a desired XML file, a destination of the custom XML file, etc. For example, the export target can be selected based on a request or input from a user. The user can select or identify the export target by, for example, dragging and dropping a metadata style sheet into a viewable portion of the display; entering information, such as a selection, into a form, a file, a page, an application, etc.; browsing and selecting the export target from an application, a file, a form, an XML file, a web page, a database, a display, etc.

The system 700 can identify one or more additional metadata style sheets from the metadata style sheets based on one or more export target selections, and generate additional custom XML files for submission with the media item to the other export targets selected. Here, the additional custom XML files can be generated by assembling at least part of the parsed metadata according to the additional metadata style sheets. In some embodiments, the system 700 can generate a separate custom XML file for submission with the media item to each of a plurality of export targets associated with the media style sheets. Here, the separate custom XML files can be generated by assembling at least part of the parsed metadata according to a respective metadata style sheet from the metadata style sheets. The system 700 can perform an automatic verification of the metadata to check the accuracy of the metadata prior to generating the custom XML file. The system 700 can also present the metadata to a user within a viewable display that allows the user to edit the metadata prior to and/or after generating the custom XML file. The system 700 can also store the metadata and/or the custom XML file for future use in creating other custom XML files. For example, the system 700 can store the metadata to create a pool of metadata, which can be used in the future to create custom XML files for selected export targets, and/or edit previous custom XML files.

The disclosure now turns to FIG. 7. With reference to FIG. 7, an example system includes a general-purpose computing device 700, including a processing unit (CPU or processor) 720 and a system bus 710 that couples various system components including the system memory 730 such as read only memory (ROM) 740 and random access memory (RAM) 750 to the processor 720. The computing device 700 can include a cache 722 of high speed memory connected directly with, in close proximity to, or integrated as part of the processor 720. The computing device 700 copies data from the memory 730 and/or the storage device 760 to the cache 722 for quick access by the processor 720. In this way, the cache provides a performance boost that avoids processor 720 delays while waiting for data. These and other modules can control or be configured to control the processor 720 to perform various actions. Other system memory 730 may be available for use as well. The memory 730 can include multiple different types of memory with different performance characteristics. It can be appreciated that the disclosure may operate on a computing device 700 with more than one processor 720 or on a group or cluster of computing devices networked together to provide greater processing capability. The processor 720 can include any general purpose processor and a hardware module or software module, such as module 1 762, module 2 764, and module 3 766 stored in storage device 760, configured to control the processor 720 as well as a special-purpose processor where software instructions are incorporated into the actual processor design. The processor 720 may essentially be a completely self-contained computing system, containing multiple cores or processors, a bus, memory controller, cache, etc. A multi-core processor may be symmetric or asymmetric.

The system bus 710 may be any of several types of bus structures including a memory bus or memory controller, a peripheral bus, and a local bus using any of a variety of bus architectures. A basic input/output (BIOS) stored in ROM 740 or the like, may provide the basic routine that helps to transfer information between elements within the computing device 700, such as during start-up. The computing device 700 further includes storage devices 760 such as a hard disk drive, a magnetic disk drive, an optical disk drive, tape drive or the like. The storage device 760 can include software modules 762, 764, 766 for controlling the processor 720. Other hardware or software modules are contemplated. The storage device 760 is connected to the system bus 710 by a drive interface. The drives and the associated computer-readable storage media provide nonvolatile storage of computer-readable instructions, data structures, program modules and other data for the computing device 700. In one aspect, a hardware module that performs a particular function includes the software component stored in a tangible computer-readable storage medium in connection with the necessary hardware components, such as the processor 720, bus 710, display 770, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the computing device 700 is a small, handheld computing device, a desktop computer, or a computer server.

Although the example embodiment described herein employs the hard disk 760, other types of computer-readable media which can store data that are accessible by a computer, such as magnetic cassettes, flash memory cards, digital versatile disks, cartridges, random access memories (RAMs) 750, read only memory (ROM) 740, a cable or wireless signal containing a bit stream and the like, may also be used in the example operating environment. Tangible computer-readable storage media expressly exclude media such as energy, carrier signals, electromagnetic waves, and signals per se.

To enable user interaction with the computing device 700, an input device 790 represents any number of input mechanisms, such as a microphone for speech, a touch-sensitive screen for gesture or graphical input, keyboard, mouse, motion input, speech and so forth. An output device 770 can also be one or more of a number of output mechanisms known to those of skill in the art. In some instances, multimodal systems enable a user to provide multiple types of input to communicate with the computing device 700. The communications interface 780 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 720. The functions these blocks represent may be provided through the use of either shared or dedicated hardware, including, but not limited to, hardware capable of executing software and hardware, such as a processor 720, that is purpose-built to operate as an equivalent to software executing on a general purpose processor. For example the functions of one or more processors presented in FIG. 7 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 740 for storing software performing the operations described below, and random access memory (RAM) 750 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The computing device 700 shown in FIG. 7 can practice all or part of the recited methods, can be a part of the recited systems, and/or can operate according to instructions in the recited tangible computer-readable storage media. Such logical operations can be implemented as modules configured to control the processor 720 to perform particular functions according to the programming of the module. For example, FIG. 7 illustrates three modules Mod1 762, Mod2 764 and Mod3 766 which are modules configured to control the processor 720. These modules may be stored on the storage device 760 and loaded into RAM 750 or memory 730 at runtime or may be stored in other computer-readable memory locations.

Embodiments within the scope of the present disclosure may also include tangible and/or non-transitory computer-readable storage media for carrying or having computer-executable instructions or data structures stored thereon. Such tangible computer-readable storage media can be any available media that can be accessed by a general purpose or special purpose computer, including the functional design of any special purpose processor as described above. By way of example, and not limitation, such tangible computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

I claim:

1. A method comprising:
receiving metadata associated with a media item;
parsing the metadata into a group of standardized fields to yield parsed metadata;
loading metadata style sheets, wherein each of the metadata style sheets is associated with a respective export target;
identifying a metadata style sheet from the metadata style sheets based on a selected export target to yield an identified metadata style sheet; and
generating, via a processor, a custom extensible markup language file for submission with the media item to the selected export target, wherein the custom extensible markup language file is generated by assembling at least part of the parsed metadata according to the identified metadata style sheet.

2. The method of claim 1, wherein the metadata is received from a plurality of sources.

3. The method of claim 2, further comprising:
identifying a deficiency in the metadata;
identifying a metadata source having information which resolves the deficiency; and
retrieving the information from the metadata source to resolve the deficiency.

4. The method of claim 3, wherein the deficiency comprises a missing portion of metadata, and wherein the information comprises a portion of metadata which corresponds to the missing portion of metadata.

5. The method of claim 1, further comprising:
identifying an additional metadata style sheet from the metadata style sheets based on a further selected export target; and
generating an additional custom extensible markup language file for submission with the media item to the further selected export target, wherein the additional custom extensible markup language file is generated by assembling at least part of the parsed metadata according to the additional metadata style sheet.

6. The method of claim 1, further comprising editing the parsed metadata prior to assembling the parsed metadata to yield edited metadata.

7. The method of claim 6, further comprising displaying the edited metadata at a device associated with a user.

8. The method of claim 1, wherein parsing the metadata into the group of standardized fields further comprises compiling the metadata into a viewable display, wherein the viewable display is configured to display the metadata and allow a user to edit the metadata from the viewable display.

9. The method of claim 1, further comprising generating a separate custom extensible markup language file for submission with the media item to each of a plurality of export targets associated with the media style sheets, wherein the separate custom extensible markup language file is generated by assembling at least part of the parsed metadata according to a respective metadata style sheet from the metadata style sheets.

10. The method of claim 1, further comprising:
identifying a metadata variation for a portion of the metadata, wherein the metadata variation comprises at least one of a spelling variation, an abbreviation, a spelling error, or a language variation; and
modifying the portion of the metadata according to the metadata variation.

11. The method of claim 1, further comprising
detecting potential errors associated with the metadata; and
presenting the potential errors to a user via a viewable display, wherein the viewable display allows the user to edit metadata fields associated with the potential errors in a live environment.

12. The method of claim 11, further comprising presenting, to the user via the viewable display, strength-tested suggestions from various metadata sources for editing at least one of the metadata fields associated with the potential errors.

13. The method of claim 1, further comprising performing an automatic verification of the metadata to check the accuracy of the metadata prior to generating the custom extensible markup language file.

14. A system comprising:
a processor; and
a computer-readable storage medium having stored therein instructions which, when executed by the processor, cause the processor to perform operations comprising:
receiving metadata associated with a media item;
parsing the metadata into a group of standardized fields to yield parsed metadata;
loading metadata style sheets, wherein each of the metadata style sheets is associated with a respective export target;
identifying a metadata style sheet from the metadata style sheets based on a selected export target to yield an identified metadata style sheet; and
generating a custom extensible markup language file for submission with the media item to the selected export target, wherein the custom extensible markup language file is generated by assembling at least part of the parsed metadata according to the identified metadata style sheet.

15. The system of claim 14, wherein the metadata is received from a plurality of sources, and wherein the computer-readable storage medium stores additional instructions which result in the operations further comprising:
identifying a deficiency in the metadata;
identifying a metadata source having information which resolves the deficiency; and
retrieving the information from the metadata source to resolve the deficiency.

16. The system of claim 14, wherein the computer-readable storage medium stores additional instructions which result in the operations further comprising:
identifying an additional metadata style sheet from the metadata style sheets based on a further selected export target; and
generating an additional custom extensible markup language file for submission with the media item to the further selected export target, wherein the additional custom extensible markup language file is generated by assembling at least part of the parsed metadata according to the additional metadata style sheet.

17. The system of claim 14, wherein parsing the metadata into the group of standardized fields further comprises compiling the metadata into a viewable display, wherein the viewable display is configured to display the metadata and allow a user to edit the metadata from the viewable display.

18. A non-transitory computer-readable storage medium having stored therein instructions which, when executed by a processor, cause the processor to perform operations comprising:
receiving metadata associated with a media item;
parsing the metadata into a group of standardized fields to yield parsed metadata;
loading metadata style sheets, wherein each of the metadata style sheets is associated with a respective export target;
identifying a metadata style sheet from the metadata style sheets based on a selected export target to yield an identified metadata style sheet; and
generating a custom extensible markup language file for submission with the media item to the selected export target, wherein the custom extensible markup language file is generated by assembling at least part of the parsed metadata according to the identified metadata style sheet.

19. The non-transitory computer-readable storage medium of claim 18, storing additional instructions which result in the operations further comprising:
identifying an additional metadata style sheet from the metadata style sheets based on a further selected export target; and
generating an additional custom extensible markup language file for submission with the media item to the further selected export target, wherein the additional custom extensible markup language file is generated by assembling at least part of the parsed metadata according to the additional metadata style sheet.

20. The non-transitory computer-readable storage medium of claim 18, wherein parsing the metadata into the group of standardized fields further comprises compiling the metadata into a viewable display, wherein the viewable display is configured to display the metadata and allow a user to edit the metadata from the viewable display.
